(19) United States
(12) Patent Application Publication
(10) Pub. No.: US 2020/0193069 A1
(43) Pub. Date: Jun. 18, 2020

(54) METHOD AND SYSTEM FOR DETERMINING WHETHER STATE INFORMATION ASSOCIATED WITH EXECUTING DEVICE HAS BEEN TAMPERED WITH

(71) Applicants: Beijing Lanxum Computer Technology Co., Ltd., Beijing (CN); Hangzhou Guyi Network Technology Co., Ltd., Hangzhou (CN)

(72) Inventors: Hao Hu, Beijing (CN); Xiaomei He, Beijing (CN); Ji Li, Beijing (CN); Qing Liu, Beijing (CN); Gang Chen, Beijing (CN); Dongwei Dong, Beijing (CN); Liguang Cen, Beijing (CN); Xingyu Chen, Beijing (CN); Han Mo, Beijing (CN); Tao Fang, Beijing (CN); Jinhai Qiao, Beijing (CN)

(21) Appl. No.: 16/429,058

(22) Filed: Jun. 2, 2019

(30) Foreign Application Priority Data
Dec. 14, 2018 (CN) 201811534690.3

(51) Int. Cl. G06F 21/86; G06F 21/64; G08B 7/00

(52) U.S. Cl. CPC G06F 21/86; G08B 7/00; G06F 21/64

(57) ABSTRACT

The present invention provides method and system for determining whether state information associated with an executing device has been tampered with, the method comprising: a first operation of acquiring first state information associated with an executing device via a control network; a second operation of acquiring second state information associated with the executing device via an independent communication channel; and a third operation of comparing the first state information with the second state information to determine whether state information associated with the executing device has been tampered with. According to the technical solution of the present invention, by introducing an independent communication channel to acquire state information associated with the executing device for comparing, and by extension of the sensor communication function and the secure monitoring device function, one may effectively manage risks of not being able to learn whether state information associated with the executing device has been tampered with when the control network is attacked.

### CROSS-REFERENCE TO RELATED APPLICATIONS

This application claims priority to China Patent Application No. CN201811534690.3, filed on Dec. 14, 2018. China Patent Application No. CN201811534690.3 is hereby incorporated by reference herein in its entirety.

### TECHNICAL FIELD

The present invention in general relates to a technical field of safety of an industrial control system, and more particularly, to a technical field of determining whether state information associated with an executing device has been tampered with.

### BACKGROUND

In a typical industrial control system attack path, when an attacker intrudes into the industrial control system and issues a control instruction, the executing device on site would generate abnormal state information due to the illegal instruction, and in order to mask his behavior, the attacker usually would use the controller to send to the operator or engineer state information that has been tampered with and pretending the device is in normal operation, such that the operator/engineer cannot learn the abnormal state of the executing device on site. For example, such a deception method was used during the over-pressure attack made by the Stuxnet to the centrifugal machine in the Iran nuclear facilities.

In an industrial control system, a sensor is an element for sensing whether any operation is suitable; the sensor directly outputs the data it senses to an input of a controller, and the controller receives the data and sends the data to an operator via a control network, and after the control network is intruded by an attacker, modifications made to state associated with the executing device would become very easy.

### SUMMARY

The method for managing tampering with state information associated with an executing device by an industrial control system aims at meeting a social demand on the severe state of network safety at present. Regarding the above problem, the present invention aims at overcoming a defect in the prior art that when a control network is attacked, it is unable to learn whether state information associated with the executing device has been tampered with, and providing a method and a system for determining whether state information associated with an executing device has been tampered with.

According to a first aspect of the present invention, it is provided a method for determining whether state information associated with an executing device has been tampered with, comprising: a first operation of acquiring first state information associated with the executing device via a control network; a second operation of acquiring second state information associated with the executing device via an independent communication channel; and a third operation of comparing the first state information with the second state information to determine whether the state information associated with the executing device has been tampered with.

Optionally, the first operation includes: sensing, by a sensor, original state information associated with the executing device; acquiring, by a control device from the sensor, the original state information; and acquiring, by the control network from the control device, state information associated with the executing device as first state information.

Optionally, the second operation includes: sensing, by the sensor, the original state information associated with the executing device; and acquiring, via an independent communication channel from the sensor, the original state information as second state information.

Optionally, the third operation includes: determining whether the first state information is consistent with the second state information; if the first state information is inconsistent with the second state information, determining that the state information associated with the executing device has been tampered with; and if the first state information is consistent with the second state information, determining that the state information associated with the executing device has not been tampered with.

Optionally, the sensor sends the original state information to the control device and the independent communication channel

Optionally, a network communication module in a security monitoring device acquires the first state information via the control network; the network communication module in the security monitoring device acquires the second state information via the independent communication channel; a data matching module in the security monitoring device acquires the first state information and the second state information from the network communication module and compares them; if the first state information is inconsistent with the second state information, the data matching module will send warning information to an abnormality processing module in the security monitoring device, and the abnormality processing module will generate visible or audible warning information to alert the operator.

According to a second aspect of the present invention, it is provided a system for determining whether state information associated with an executing device has been tampered with, comprising a security monitoring device, a control network, an independent communication channel, at least one executing device, and at least one sensor, wherein: the sensor is connected to the executing device to sense original state information associated with the executing device; the sensor corresponding to the executing device on a one-to-one basis; the control network is connected to the sensor to acquire the original state information from the sensor; the security monitoring device is connected to the control network to acquire from the control network state information associated with the executing device as first state information; the independent communication channel is connected to the sensor to acquire the original state information from the sensor; the security monitoring device is connected to the independent communication channel to acquire via the independent communication channel the original state information as second state information; the security monitoring device compares the first state information with the second state information to determine whether state information associated with the executing device has been tampered with.

Optionally, further comprising a control device, which is located between the sensor and the control network and used for acquiring the original state information from the sensor and in accordance with received instructions, sending state information associated with the executing device to a device on the control network.

Optionally, comparing, by the security monitoring device, the first state information with the second state information to determine whether state information associated with the executing device has been tampered with comprises: determining, by the security monitoring device, whether the first state information is consistent with the second state information; if the first state information is inconsistent with the second state information, determining that the state information associated with the executing device has been tampered with; if the first state information is consistent with the second state information, determining that the state information associated with the executing device has not been tampered with.

Optionally, the sensor is configured to send the original state information to the control device and the independent communication channel.

Optionally, the security monitoring device comprises a network communication module, a data matching module and an abnormality processing module, wherein: the network communication module is connected to the control network and the independent communication channel, respectively to acquire via the control network the first state information and via the independent communication channel the second state information; the data matching module is connected to the network communication module to acquire from the network communication module the first state information and the second state information and compare them; if the first state information is inconsistent with the second state information, the data matching module will send warning information to the abnormality processing module; the abnormality processing module is connected to the data matching module to process the received warning information and generate visible or audible information to alert the operator.

According to a third aspect of the present invention, it is provided an apparatus for determining whether state information associated with an executing device has been tampered with, comprising: first means for acquiring from a control network first state information associated with the executing device; second means for acquiring from an independent communication channel second state information associated with the executing device; and third means for comparing the first state information with the second state information to determine whether the state information associated with the executing device has been tampered with.

According to a fourth aspect of the present invention, it is provided a controller for determining whether state information associated with an executing device has been tampered with, comprising: a memory; and a processor coupled to the memory, the processor configured to execute the method according to any of the embodiments in the first aspect of the present invention based on instructions stored in the memory.

According to a fifth aspect of the present invention, it is provided a computer-readable storage medium with computer program instructions stored thereon, when executed by one or more processors, the instructions carrying out the method according to any of the embodiments in the first aspect of the present invention.

The present invention has the following advantages:
1) According to the technical solution of the present invention, by introducing an independent communication channel to acquire state information associated with an executing device and comparing the information, it is effectively prevented that when a control network is attacked, it is unable to learn whether state information associated with the executing device has been tampered with;
2) According to the technical solution of the present invention, by extension of the sensor communication function and the security monitoring device function, two communication interfaces of the sensor, and data matching function of the security monitoring device are implemented, thereby implementing the technical solution of the present invention, which is simple, convenient, safe and reliable.

### BRIEF DESCRIPTION OF THE DRAWINGS

FIG. 1 is a flow chart showing a method for determining whether state information associated with an executing device has been tampered with according to the present invention.

FIG. 2 is a schematic diagram showing a system for determining whether state information associated with an executing device has been tampered with according to the present invention.

FIG. 3 is a schematic diagram showing a system comprising a control device according to the present invention.

FIG. 4 is a schematic diagram showing one embodiment of a system for determining whether state information associated with an executing device has been tampered with according to the present invention.

FIG. 5 is a schematic diagram showing one embodiment of an independent communication channel in a system according to the present invention.

FIG. 6 is a schematic diagram showing one embodiment of a sensor according to the present invention.

FIG. 7 is a schematic diagram showing one embodiment of a security monitoring device according to the present invention.

FIG. 8 is a flow chart showing one embodiment of a working procedure of a security monitoring device according to the present invention.

FIG. 9 is a block diagram showing an apparatus for determining whether state information associated with an executing device has been tampered with according to the present invention.

FIG. 10 shows a schematic diagram showing a controller for determining whether state information associated with an executing device has been tampered with according to the present invention.

FIG. 11 shows a program product according to an embodiment of the present invention.

### DETAILED DESCRIPTION OF THE INVENTION

Optimal examples of the present invention will be described in detail below with reference to the drawings. The reference signs refer to the components and techniques in the present invention, such that the advantages and characteristics of the present invention under suitable environments can be easy to understand. The following are embodiments of the present invention, and embodiments relating to the claims without explicit description also fall into the scope of the claims.

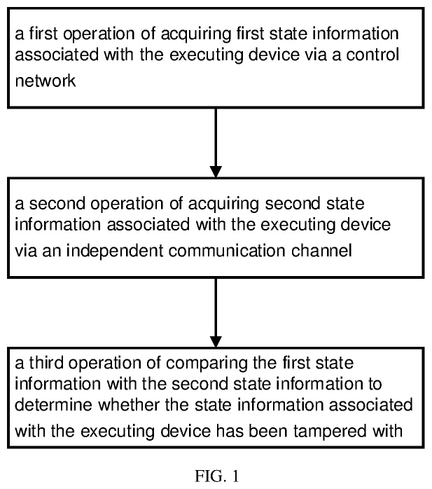

FIG. 1 is a flow chart showing a method for determining whether state information associated with an executing device has been tampered with according to the present invention.

As shown in FIG. 1, the present invention provides a method for determining whether state information associated with an executing device has been tampered with, comprising: a first operation of acquiring first state information associated with the executing device via a control network; a second operation of acquiring second state information associated with the executing device via an independent communication channel; and a third operation of comparing the first state information with the second state information to determine whether the state information associated with the executing device has been tampered with.

The state information associated with the executing device includes state information of the executing device itself and state information associated with the executing device in a surrounding environment of the executing device. The state information associated with the executing device in a surrounding environment of the executing device includes ambient temperature, moisture, vibration, pressure and the like. For example, when a fire takes place around the executing device, damages or influences may be caused to the executing device, or even safety of the entire system is threatened. Thus, it is very important to monitor such state information.

The control network may be an industrial control network in various forms, including, but being not limited to, a SCADA system, a DCS system, and a PLC-based system and the like. The independent communication channel refers to a communication channel independent of the control network, including, but being not limited to, a bus, a sensor network, a wireless communication manner, and a wired communication manner and the like.

Optionally, the first operation includes: sensing, by a sensor, original state information associated with the executing device; acquiring, by a control device from the sensor, the original state information; and acquiring, by the control network from the control device, state information associated with the executing device as first state information.

Optionally, the third operation includes: determining whether the first state information is consistent with the second state information; if the first state information is inconsistent with the second state information, determining that the state information associated with the executing device has been tampered with; and if the first state information is consistent with the second state information, determining that the state information associated with the executing device has not been tampered with. The third operation is an operation in which state information from two different channels are compared to determine whether state information associated with the executing device is tampered with. Since the control network and the independent communication channel are two different communication channels, when the control network is attacked, state information associated with the executing device that is transmitted via the control network may be changed, and in this case, the first state information and the second state information would be inconsistent.

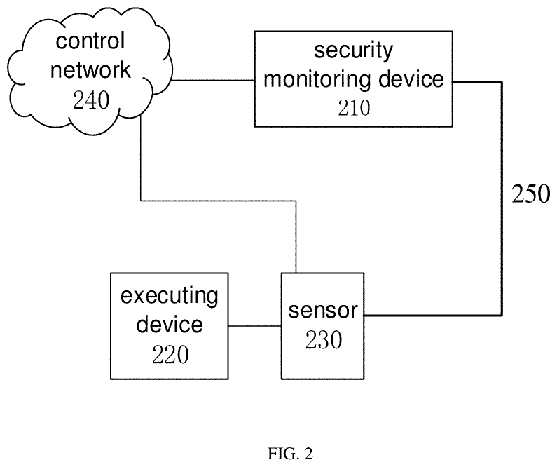

FIG. 2 is a schematic diagram showing a system for determining whether state information associated with an executing device has been tampered with according to the present invention.

As shown in FIG. 2, the technical solution of the present invention provides a system for determining whether state information associated with an executing device 220 has been tampered with, comprising a security monitoring device 210, a control network 240, an independent communication channel 250, an executing device 220, and a sensor 230, wherein: the sensor 230 is connected to the executing device 220 to sense original state information associated with the executing device 220; the control network 240 is connected to the sensor 230 to acquire the original state information from the sensor 230; the security monitoring device 210 is connected to the control network 240 to acquire from the control network 240 state information associated with the executing device 220 as first state information; the independent communication channel 250 is connected to the sensor 230 to acquire the original state information from the sensor 230; the security monitoring device 210 is connected to the independent communication channel 250 to acquire via the independent communication channel 250 the original state information as second state information; the security monitoring device 210 compares the first state information with the second state information to determine whether state information associated with the executing device 220 has been tampered with.

The control network 240 may comprise a switchboard, and the security monitoring device 210 may be connected to the switchboard in the control network 240 to acquire data including control commands and state information transmitted within the control network. The security monitoring device 210 may also communicate with the onsite sensor 230 via the independent communication channel 250 to acquire state information associated with the executing device 220.

The sensor 230 is a detecting device that is capable of sensing measured information and converting the sensed information into electrical signals or information in a desired form in accordance with a certain rule so as to meet requirements on information transmission, processing, storage, display, recording and control. The sensor 230 may output the state information to the control network 240 or to the independent communication channel 250.

The sensor 230 senses the state information associated with the executing device 220 as original state information. The original state information may be divided into two signals to transmit to the control network 240 and the independent communication channel 250. The security monitoring device 210 may acquire state information associated with the executing device 220 via two channels, and the two channels are the control network 240 and the independent communication channel 250. Since the independent communication channel 250 is independent of the control network 240 and is directly connected to the sensor 230, the second state information acquired by the security monitoring device 210 from the independent communication channel 250 shall be the same as the original state information. The control network 240 may be attacked, such that original state information transmitted over the control network may be tampered with, so the first state information acquired by the security monitoring device 210 from the control network 240 may be the same as the original state information, or may be state information that has been tampered with, i.e., it may be different from the original state information.

The security monitoring device 210 may be configured to compare the first state information with the second state information to determine whether state information associated with the executing device 220 has been tampered with. For example, optionally, the security monitoring device 210 determines whether the first state information is consistent with the second state information to determine whether state information associated with the executing device 220 has been tampered with; if the first state information is inconsistent with the second state information, it is determined that the state information associated with the executing device 220 has been tampered with; if the first state information is consistent with the second state information, it is determined that the state information associated with the executing device 220 has not been tampered with. When the control network 240 is attacked, the first state information may be different from the original state information, such that the first state information is inconsistent with the second state information.

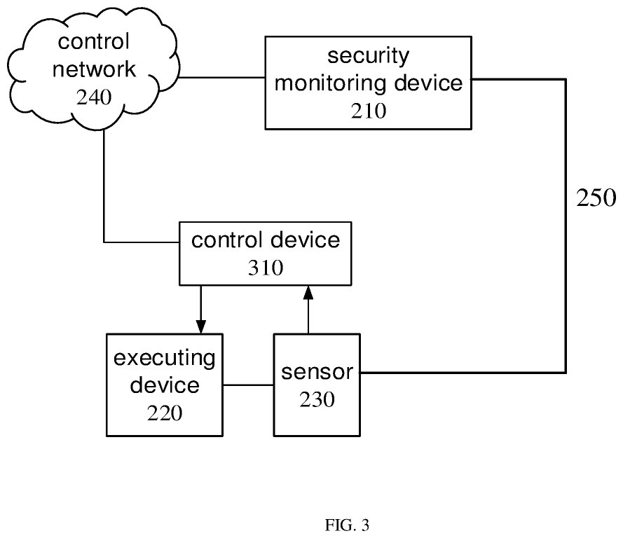

FIG. 3 is a schematic diagram showing a system comprising a control device according to the present invention.

As shown in FIG. 3, according to one embodiment of the present invention, a control device 310 may be further comprised. The control device 310 is located between the sensor 230 and the control network 240, and may be used for acquiring the original state information from the sensor 230 and sending the state information associated with the executing device 220 to the control network 240 according to a received instruction.

The control device 310 is connected to the control network 240 and also to the sensor 230 and the executing device 220, respectively. The control device 310 may output a control instruction signal to the executing device 220 and receive state information data from the sensor 230. The executing device 220 may receive a control instruction from the control device 310 and execute the control instruction. The sensor 230 may output state information to the control device 310 and send it to the independent communication channel 250.

A first operation method according to the embodiment may comprise: sensing, by the sensor 230, original state information associated with the executing device 220; acquiring, by the control device 310 from the sensor 230, the original state information; and acquiring, by the security monitoring device 210 via the control network 350 from the control device 310, state information associated with the executing device 220 as first state information. A second operation method according to the embodiment may comprise: sensing, by the sensor 230, original state information associated with the executing device 220; acquiring, by the security monitoring device 210 via the independent communication channel 250 from the sensor 230, the original state information as second state information. A third operation method according to the embodiment may comprise: comparing, by the security monitoring device 210, first state information with second state information to determine whether state information associated with the executing device 220 has been tampered with.

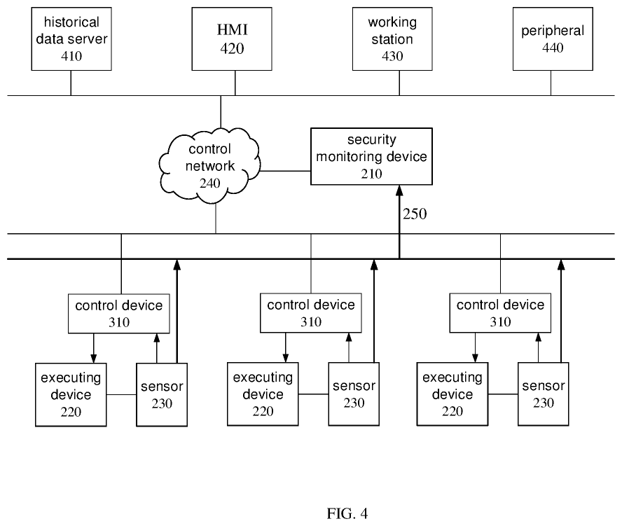

FIG. 4 is a schematic diagram showing one embodiment of a system for determining whether state information associated with an executing device has been tampered with according to the present invention.

As shown in FIG. 4, according to the embodiment, further comprising a plurality of executing devices 220, a plurality of sensors 230, etc. The control network 240 may be connected to a plurality of devices, which may include but be not limited to a historical data server 410, a human-machine interface (HMI) 420, a working station 430, and a peripheral 440. The independent communication channel 250 may be in a bus form as shown in FIG. 4.

The control device 310 may receive a control instruction sent from devices on the control network 240 and output the control instruction signal to the executing device 220. The executing device 220 may receive a control instruction from the control device 310 and execute the control instruction. The control device 310 may also send state information associated with the executing device 220 to the devices on the control network 240 according to the received instruction. For example, it may feedback the state information to the HMI420, the working station 430 and the like.

Optionally, a switchboard in the control network 240 may detect all net elements over the industrial control network 240, such as the control device 310, the historical data server 410, the HMI 420, the working station 430, and the peripheral 440 and the like, as well as interactive data there among.

When there are a plurality of executing devices 220 and sensors 230, optionally, the number of the sensors 230 may be identical with and correspond to the number of the executing devices 220 on a one-to-one basis. The correspondence on a one-to-one basis means state information associated with one executing device 220 would be sensed by a respective sensor 230. It shall be understood that although the executing devices 220 are not present in a separate form as shown in FIG. 4 and may be integrated to form an entire module, the entire module may be divided physically or logically into a number of modules corresponding to the sensors 230.

When there are a plurality of executing devices 220, optionally, the security monitoring device 210 may monitor whether state information of a designated executing device 220 has been tampered with according to the control instruction and the degree of importance of the respective executing device 220.

According to one embodiment of the present invention, the security monitoring device 210 may be connected to the switchboard in the control network 240 to acquire control instructions, state information data, etc. transmitted within the control network 240, and meanwhile, the security monitoring device 210 further communicates with an onsite sensor 230 via the independent communication channel 250. The security monitoring device 210 may preset control instruction to be monitored and state data associated with the executing device 220, such as a temperature state, and when data obtained from the switchboard in the control network 240 and resolved by the security monitoring device 210 are the control instruction and state data that are designated in advance to be monitored, for example, the state data is a temperature relating to the executing device 220, it serves as first state information; the security monitoring device 210 acquires from the independent communication channel 250 state information data sensed by the sensor 230 and associated with the executing device 220, which serves as second state information; and the security monitoring device 210 compares the state data from the two channels; if the first state information is consistent with the second state information, the security monitoring device 210 may continue to monitor the next piece of captured information; otherwise, it is deemed that the analyzed state information data is abnormal, thereby performing abnormality processing, such as giving an alarm, etc.

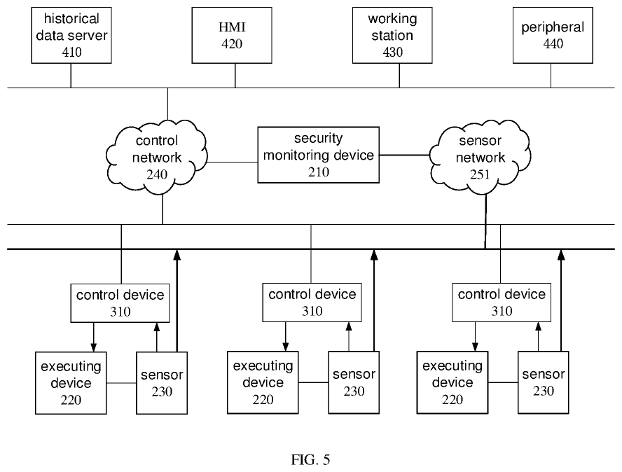

FIG. 5 is a schematic diagram showing one embodiment of an independent communication channel in a system according to the present invention.

As shown in FIG. 5, according to one embodiment of the present invention, the independent communication channel 250 may be a sensor network 251. The sensor network 251 may include a switchboard. The sensor 230 may directly send sensed state information via the sensor network 251 to the security monitoring device 210. The security monitoring device 210 acquires state information associated with the executing device 220 sensed by the sensor 230 via the sensor network 251.

The independent communication channel 250 may also be in a wired communication manner or a wireless communication manner.

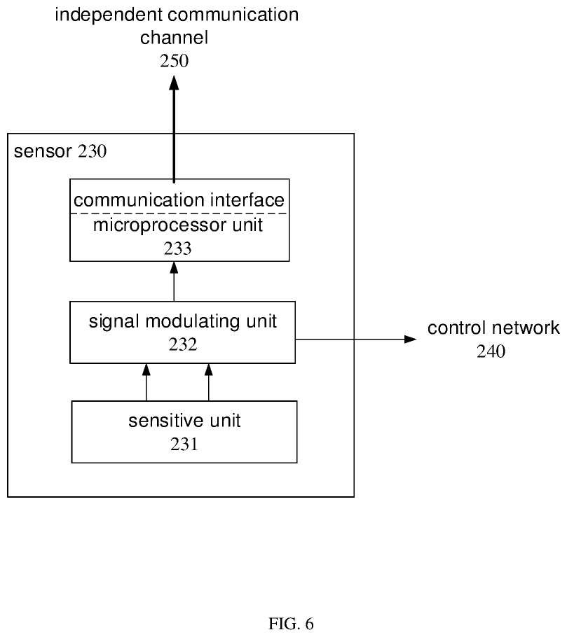

FIG. 6 is a schematic diagram showing one embodiment of a sensor according to the present invention.

According to one embodiment of the present invention, the sensor 230 is configured to send the original state information to the control network 240 and the independent communication channel 250. Optionally, the sensor 230 may also send the original state information to the control device 310 and the independent communication channel 250.

Extension of the communication function of the sensor 230 may be advantageous to the object of the present invention. Improvements made by the present invention on the sensor mainly lie in improvements on the communication function, such that the improved sensor 230 may, in addition to a traditional communication function, send information data to an external device, such as the security monitoring device 210 according to the present invention, via an independent communication channel 250 that is independent of the control network 240. The improved sensor 230 may output the same state information signal to both the control network 240 and the independent communication channel 250.

As shown in FIG. 6, the sensor 230 may comprise a sensitive unit 231, a signal modulating unit 232, and a microprocessor unit 233, the microprocessor unit 233 including a communication interface. The sensitive unit 231 may sense state information of the executing device connected thereto and external environment information and generate an electrical signal to be sent to the signal modulating unit 232; the signal modulating unit 232 converts the received electric signal to a range that is acceptable by the control device 310 or the control network 240 and outputs it to the control device 310 or via the control network 240; the microprocessor unit 233 receives the state information signal modulated by the signal modulating unit 232, and converts it to a predefined transmission format to be outputted via the independent communication channel 250 to, for example, the security monitoring device 210.

According to the technical solution of the present invention, extension of the function of the sensor 230 deals with a case of tampering with state information associated with the executing device in the control network, so that the present invention may achieve the purpose of determining whether state information associated with the executing device has been tampered with.

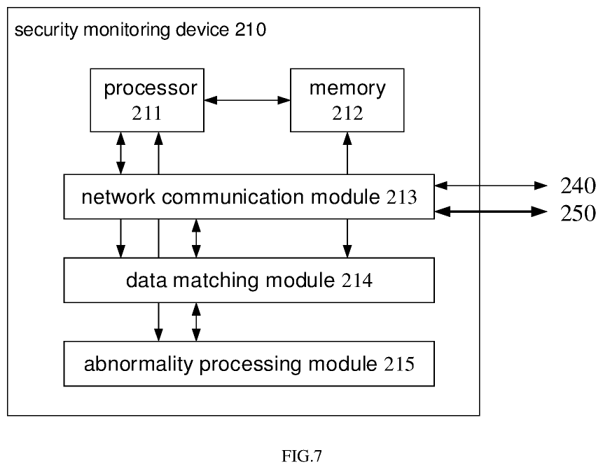

FIG. 7 is a schematic diagram showing one embodiment of a security monitoring device according to the present invention.

According to one embodiment of the present invention, as shown in FIG. 7, the security monitoring device 210 includes a network communication module 213, a data matching module 214, and an abnormality processing module 215, wherein the network communication module 213 is connected to the control network 240 and the independent communication channel 250, respectively to acquire via the control network 240 the first state information and via the independent communication channel 250 the second state information; the data matching module 214 is connected to the network communication module 213 to acquire from the network communication module 213 the first state information and the second state information and compare them; if the first state information is inconsistent with the second state information, the data matching module 214 will send warning information to the abnormality processing module 215; the abnormality processing module 215 is connected to the data matching module 214 to process the received warning information and generate visible or audible information to alert the operator.

The security monitoring device 210 further includes a processor 211 and a memory 212. The processor 211 is connected to the memory 212 and the network communication module 213, respectively, to calculate and manage the respective modules in the security monitoring device 210; the memory 212 is further connected to the network communication module 213 to store original data, intermediate conversion data and other data that are needed to store; the network communication module 213 is used to acquire data from the control network 240 and the independent communication channel 250, respectively; the data matching module 214 is used for comparing the first state information with the second state information; if the first state information is consistent with the second state information, proceeding to compare the next pair of state information; if the first state information is inconsistent with the second state information, alarm information is transmitted to the abnormality processing module 215; the abnormality processing module will send audible or visible alarm information to remind the operator and record. The visible or audible alarm information includes, but not limited to, one or more of images, text, numbers, audio, video, animation, rendering, light, alarm lamp, twinkling, and sound. The audible and visible alarm information may be simultaneously displayed, such as an alarm lamp with both light and sound.

According to the technical solution of the present invention, by extension of the function of the security monitoring device 210 to deal with a case of tampering with state information associated with an executing device in a control network, the object of the present invention to determine whether state information associated with the executing device has been tampered with is achieved.

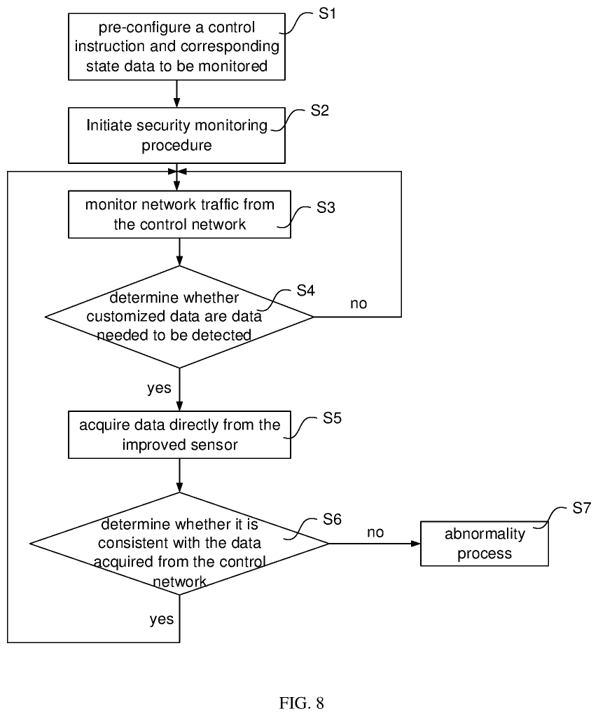

FIG. 8 is a flow chart showing one embodiment of a working procedure of a security monitoring device according to the present invention.

As shown in FIG. 8, according to one embodiment of the working flow of the security monitoring device 210 according to the present invention, as shown in step S1, firstly, it is necessary to pre-configure a control instruction to be monitored and corresponding state data; as shown in step S2, a security monitoring procedure is initiated; as shown in step S3, a network communication module 213 in the security monitoring device 210 acquires network traffic from the control network 240; as shown in step S4, it is determined whether customized data in the traffic from the control network 240 are data needed to be detected; if they are, proceeding step S5; otherwise, returning to step S3; as shown in step S5, the network communication module 213 in the security monitoring device 210 acquires from the independent communication channel 250 state information associated with the executing device 220; as shown in step S6, the data matching module 214 in the security monitoring device 210 compares state information associated with the executing device 220 that is acquired from the independent communication channel 250 with state information acquired from the control network 240; if they are consistent, returning to step S3, and if not, the data matching module 214 in the security monitoring device 210 sends abnormality information to the abnormality processing module 215, such that the abnormality processing module 215 deals with the case and provides visible and/or audible alarm information.

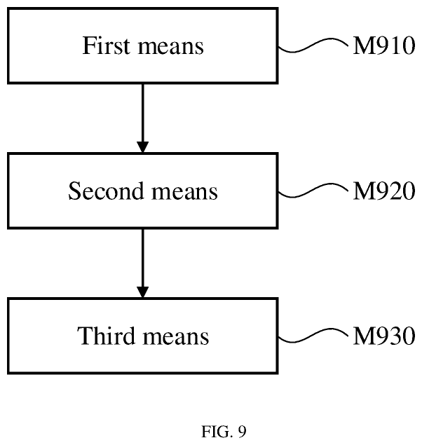

FIG. 9 is a block diagram showing an apparatus for determining whether state information associated with an executing device has been tampered with according to the present invention.

As shown in FIG. 9, the apparatus of the present invention includes: first means M910 for acquiring from a control network first state information associated with the executing device; second means M920 for acquiring from an independent communication channel second state information associated with the executing device; and third means M930 for comparing the first state information with the second state information to determine whether the state information associated with the executing device has been tampered with.

The advantages of the present invention lie in:
1) according to the technical solution of the present invention, by introducing an independent communication channel to acquire state information associated with an executing device and comparing the information with state information associated with the same executing device acquired from a control network, it is effectively prevented that when a control network is attacked, it is unable to learn whether state information associated with the executing device has been tampered with;
2) According to the technical solution of the present invention, by extension of the sensor communication function and the security monitoring device function, two communication interfaces of the sensor, and data matching function of the security monitoring device are implemented, thereby implementing the technical solution of the present invention, which is simple, convenient, safe and reliable.

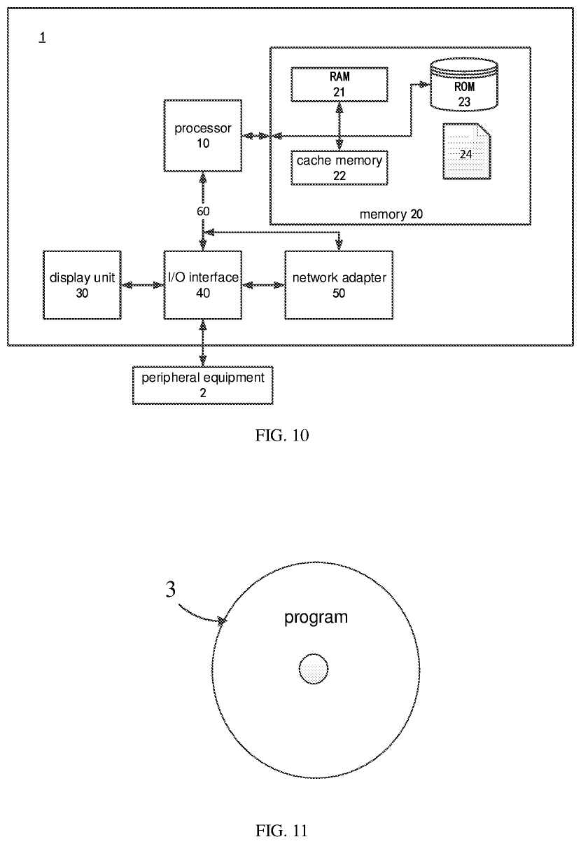

FIG. 10 shows a schematic diagram showing a controller for determining whether state information associated with an executing device has been tampered with according to the present invention. The controller 1 displayed in FIG. 10 is only an example, which shall not limit functions and range of utilization of the example of the present invention.

As shown in FIG. 10, the controller 1 is represented by a general computing device, including, but being not limited to: at least one processor 10, at least one memory 20, and a bus 60 connected to different system components.

The bus 60 represents one or more of several kinds of bus structures, including a memory bus or a memory controller, a peripheral bus, a graphic accelerating port, a processor or a local bus having a bus structure according to any of a plurality of bus structures.

The memory 20 may include a readable medium in the form of a volatile memory, such as a random access memory (RAM) 21 and/or a cache memory 22, and may further include a read-only memory (ROM) 23.

The memory 20 may further include a program module 24, which includes but is not limited to: an operation system, one or more applications, other program modules and program data. Each or certain combinations of these examples may include implementation in a network environment.

The controller 1 may communicate with one or more peripheral equipment 2 and may communicate with one or more other equipments. Such communication may be performed via an input/output (I/O) interface 40, and displayed on a display unit 30. Further, the controller 1 may communicate, via a network adapter 50, with one or more networks (for example, local area network (LAN), wide area network (WAN) and/or common network, such as Internet). As shown in the figure, the network adapter 50 communicates with other modules in the controller 1 via a bus 60. It shall be understood that although not shown in the figure, the controller 1 may be used with other hardware and/or software modules, including but being not limited to, micro-codes, device drivers, redundancy processing units, external disk driving arrays, RAID systems, tape drivers and data backup storage systems.

In some possible embodiments, the various aspects of the present invention may be implemented as a program product, including program codes, which, when executed by a processor, cause the processor to carry out the method described above.

The program product may employ any combination of one or more readable media. The readable medium may be a readable signal medium or a readable storage medium. The readable storage medium, for example, may be, but not limited to, an electric, magnetic, optical, electromagnetic, IR or semiconductor system, apparatus or device, or any combination thereof. More particular examples of the readable storage medium (not limited to) include: an electrical connection with one or more wires, a portable disc, a hard disc, a random access memory (RAM), a read-only memory (ROM), an erasable programmable read-only memory (EPROM or flash), optical fiber, a portable compact disc read-only memory (CD-ROM), an optical memory device, a magnetic memory device, or any suitable combination thereof.

FIG. 11 shows a program product 3 according to an embodiment of the present invention, which may employ a portable compact disc read-only memory (CD-ROM) and include program codes, and run on a terminal device such as a personal computer. However, program products according to the present invention are not limited thereto. In the document, the readable storage medium may be any tangible medium containing or storing programs, which can be used by or in combination with an instruction executing system, an apparatus or a device.

The program codes of the present invention may be written by any combination of one or more program design languages. The program design languages include object-oriented program design languages, such as Java, C++ and the like, and conventional procedural program design languages, such as “C” language or similar program design languages. The program codes can be executed completely or partially on a user computing device, as an independent software package, partially on a user computing device and partially on a remote computing device, or completely on a remote computing device or server. In a case where a remote computing device is involved, the remote computing device may be connected to the user computing device via any type of network, including local area network (LAN) or wide area network (WAN), or connected to an external computing device (for example, via the Internet using an Internet service provider).

In addition, although operations of the method according to the present invention are described in the drawings in a specific sequence, this does not require or suggest that such operations have to be performed in such a specific sequence, or all the operations as shown have to be performed to achieve the desired result. Additionally or optionally, certain steps may be omitted, and a plurality of steps may be combined to one step, and/or one step may be divided into a plurality of steps.

It shall be noted that the above examples only demonstrate the present invention instead of limiting it, and those skilled in the art may, without departing from the scope of the attached claims, design alternative examples. In the claims, parenthesized reference signs shall by no means set limitations on the claims.

1. A method for determining whether state information associated with an executing device has been tampered with, comprising:
a first operation of acquiring first state information associated with the executing device via a control network;
a second operation of acquiring second state information associated with the executing device via an independent communication channel; and
a third operation of comparing the first state information with the second state information to determine whether the state information associated with the executing device has been tampered with.

2. The method according to claim 1, wherein the first operation includes:
sensing, by a sensor, original state information associated with the executing device;
acquiring, by a control device from the sensor, the original state information; and
acquiring, by the control network from the control device, state information associated with the executing device as first state information.

3. The method according to claim 2, wherein the second operation includes:
sensing, by the sensor, the original state information associated with the executing device; and acquiring, via an independent communication channel from the sensor, the original state information as second state information.

4. The method according to claim 1, wherein the third operation includes:
determining whether the first state information is consistent with the second state information;
if the first state information is inconsistent with the second state information, determining that the state information associated with the executing device has been tampered with; and
if the first state information is consistent with the second state information, determining that the state information associated with the executing device has not been tampered with.

5. The method according to claim 3, wherein:
the sensor sends the original state information to the control device and the independent communication channel.

6. The method according to claim 1, wherein:
a network communication module in a security monitoring device acquires the first state information via the control network;
the network communication module in the security monitoring device acquires the second state information via the independent communication channel;
a data matching module in the security monitoring device acquires the first state information and the second state information from the network communication module and compares them;
if the first state information is inconsistent with the second state information, the data matching module will send warning information to an abnormality processing module in the security monitoring device, and the abnormality processing module will generate visible or audible warning information to alert the operator.

7. A system for determining whether state information associated with an executing device has been tampered with, comprising a security monitoring device, a control network, an independent communication channel, at least one executing device, and at least one sensor, wherein:
the sensor is connected to the executing device to sense original state information associated with the executing device; the sensor corresponding to the executing device on a one-to-one basis;
the control network is connected to the sensor to acquire the original state information from the sensor;
the security monitoring device is connected to the control network to acquire from the control network state information associated with the executing device as first state information;
the independent communication channel is connected to the sensor to acquire the original state information from the sensor;
the security monitoring device is connected to the independent communication channel to acquire via the independent communication channel the original state information as second state information;
the security monitoring device compares the first state information with the second state information to determine whether state information associated with the executing device has been tampered with.

8. The system according to claim 7, further comprising a control device which is located between the sensor and the control network and used for acquiring the original state information from the sensor, and in accordance with received instructions, sending state information associated with the executing device to a device on the control network.

9. The system according to claim 7, wherein comparing, by the security monitoring device, the first state information with the second state information to determine whether state information associated with the executing device has been tampered with comprises: determining, by the security monitoring device, whether the first state information is consistent with the second state information;
if the first state information is inconsistent with the second state information, determining that the state information associated with the executing device has been tampered with;
if the first state information is consistent with the second state information, determining that the state information associated with the executing device has not been tampered with.

10. The system according to claim 8, wherein:
the sensor is configured to send the original state information to the control device and the independent communication channel.

11. The system according to claim 7, wherein the security monitoring device comprises a network communication module, a data matching module and an abnormality processing module,
the network communication module is connected to the control network and the independent communication channel, respectively to acquire via the control network the first state information and via the independent communication channel the second state information;
the data matching module is connected to the network communication module to acquire from the network communication module the first state information and the second state information and compare them;
if the first state information is inconsistent with the second state information, the data matching module will send warning information to the abnormality processing module;
the abnormality processing module is connected to the data matching module to process the received warning information and generate visible or audible information to alert the operator.

12. A controller for determining whether state information associated with an executing device has been tampered with, comprising: a memory; and
a processor coupled to the memory, the processor configured to execute the methods according to claim 1 based on instructions stored in the memory.
